(19) United States
(12) Patent Application Publication
(10) Pub. No.: US 2005/0024506 A1
(43) Pub. Date: Feb. 3, 2005

(54) Camera module adjusting method

(75) Inventors: Toshio Nakakuki, Gifu (JP); Atsushi Noda, Gifu (JP)

Correspondence Address: MORRISON & FOERSTER LLP, 1650 TYSONS BOULEVARD, SUITE 300, MCLEAN, VA, 22102, US

(73) Assignee: Sanyo Electric Co., Ltd., Moriguchi-city (JP)

(21) Appl. No.: 10/888,958

(22) Filed: Jul. 12, 2004

(30) Foreign Application Priority Data
Jul. 11, 2003 (JP) 2003-273190

(51) Int. Cl. G03B 17/00

(52) U.S. Cl. 348/231.99

(57) ABSTRACT

The invention provides a camera module adjusting method which reduces load of work of a camera adjusting step on a side of a downstream product manufacturer. In the camera module adjusting method of the invention, camera adjustment data (e.g. data on adjustment of white balance characteristics of a CCD and adjustment of a mechanical shutter which varies among CCDs or products) and a module control program are stored in a flash memory of the camera module in a camera module manufacturing procedure, and then this camera module is sent to a downstream product manufacturer. Then, in a downstream product manufacturing procedure, the camera module is mounted on the motherboard for a downstream product, and the motherboard is mounted in the downstream product.

### CROSS-REFERENCE TO RELATED APPLICATIONS

This application claims priority from Japanese Patent Application No. 2003-273190, which is incorporated herein by reference in its entirety.

### BACKGROUND OF THE INVENTION

1. Field of the Invention

This invention relates to a method of adjusting and assembling a camera module, particularly to a method of adjusting white balance characteristics and so on of a camera module using a CCD.

2. Description of the Related Art

In recent years, a camera module using a CCD (charge coupled device) as an imager is being used in a cellular phone or an object recognizing device, and its application range is broadening. Particularly, a camera module, in which a DSP (digital signal processor) serving as an image processor performs image recognition, data compression, white balance adjustment, and so on to an image signal outputted from the CCD, is being developed.

A structure of a conventional camera module will be described below as an example with reference to a drawing.

FIG. 3 is a block diagram of a structure of the conventional camera module. A camera module 20 is configured of a CCD 21, an A/D converter 22 converting an analog image signal outputted from the CCD 21 into a digital image signal and a DSP 23 processing the digital image signal outputted from the A/D converter 22. This camera module 20 is mounted on a motherboard (not shown). The motherboard is mounted with a CPU 24 for controlling the DSP 23, a flash memory 25, and so on, independently of the camera module 20. The flash memory 25 mounted on the motherboard is stored with camera adjustment data (including data on adjustment of white balance characteristics of the CCD 21 and adjustment of a mechanical shutter which varies among CCDs or products) and a module control program.

The DSP 23 performs predetermined image signal processing or camera adjustment (e.g. adjustment of a white balance or adjustment of a mechanical shutter which varies among CCDs or products) by reading out the module control program or the camera adjustment data (e.g. data on adjustment of white balance characteristics) from the flash memory 25 mounted on the motherboard, by a command of the CPU 24 mounted on the motherboard.

Next, steps from adjusting of the conventional camera module 20 based on predetermined camera adjustment data to mounting of the module 20 in a downstream product, such as a cellular phone, will be described below as an example with reference to a drawing.

FIG. 4 is a flow chart showing such steps. Among steps a2 to g2 shown in FIG. 4, the steps a2 and b2 are performed by a module manufacturer as follows.

First, at the step a2, the camera module 20 described above is manufactured by a module manufacturer. Then, at the step b2, the camera module 20 is sent to a downstream product manufacturer who mounts the camera module 20 in a downstream product.

Then, the downstream product manufacturer performs the steps c2 to g2 as follows.

At the step c2, the camera module 20 is mounted on a motherboard. Then, at the step d2, the camera adjustment data (e.g. data on adjustment of white balance characteristics of the CCD 21 and adjustment of a mechanical shutter which varies among CCDs or products) and the module control program are stored in the flash memory 25 mounted on the motherboard. At the step e2, the camera adjustment data are set in the DSP and so on of the camera module 20, that is, the camera module 20 is calibrated. At the step f2, the motherboard mounted with the camera module 20 after the calibration is mounted in a downstream product. Then, this downstream product is sent to the market at the step g2.

Such conventional art is disclosed in Japanese Patent Application Publication No. 2001-136545.

However, the calibration of the conventional CCD camera module 20 to meet specifications and purposes of the downstream products (e.g. cellular phone) has been performed by the downstream product manufacturer. That is, the downstream product manufacturer stores the camera adjustment data (including data on adjustment of white balance characteristics of the CCD and adjustment of a mechanical shutter which varies among CCDs or products) and the module control program in the flash memory 25 mounted on the motherboard according to specification and purpose of each of the downstream products. This causes a problem of increasing workload on the part of the downstream product manufacturer.

### SUMMARY OF THE INVENTION

The invention is directed to a camera module adjusting method, in which a downstream product manufacturer need not perform a step of storing camera adjustment data and a module control program in a memory mounted on a motherboard in a manufacturing procedure of a downstream product.

In the camera module adjusting method of the invention, the camera module has a CCD as an imager, an A/D converter for converting an output signal from the CCD into a digital signal, a DSP as an image processor for performing image-processing to the digital signal, and a flash memory stored with camera adjustment data (e.g. data on adjustment of white balance characteristics of the CCD and adjustment of a mechanical shutter which varies among CCDs or products) and a module control program (e.g. a sequence for controlling camera module operation) which are necessary for the image-processing.

In a camera module manufacturing procedure, the camera adjustment data and the module control program corresponding to the downstream product are stored in the flash memory. Then, the camera module is sent to the downstream product manufacturer. In a downstream product manufacturing procedure, the camera module is mounted on the motherboard for the downstream product, and the motherboard is mounted on the downstream product.

Furthermore, in the invention, the described step of automatically adjusting the camera module is performed after the camera module is mounted on the motherboard in the downstream product manufacturing procedure.

### BRIEF DESCRIPTION OF THE DRAWINGS

FIG. 1 is a block diagram showing a structure of a camera module of an embodiment of the invention.

FIG. 2 is a flow chart showing steps from manufacturing of the camera module to mounting of the camera module into a downstream product of the embodiment of the invention.

FIG. 3 is a block diagram showing a structure of a camera module of a conventional art.

FIG. 4 is a flow chart showing steps from manufacturing of the camera module to mounting of the camera module in a downstream product of a conventional art.

### DETAILED DESCRIPTION OF THE INVENTION

A structure of a CCD camera module of an embodiment of the invention will be described with reference to the drawings.

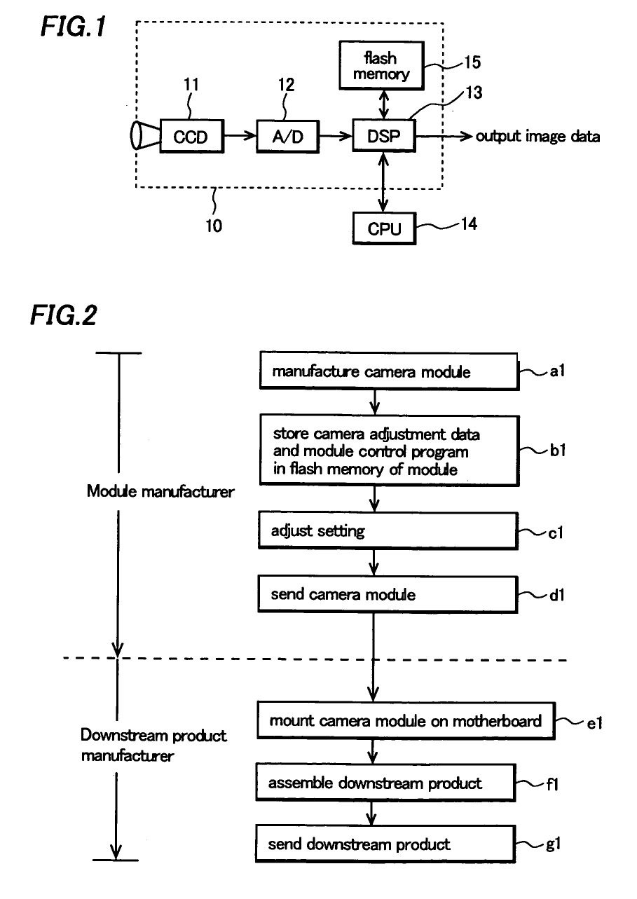

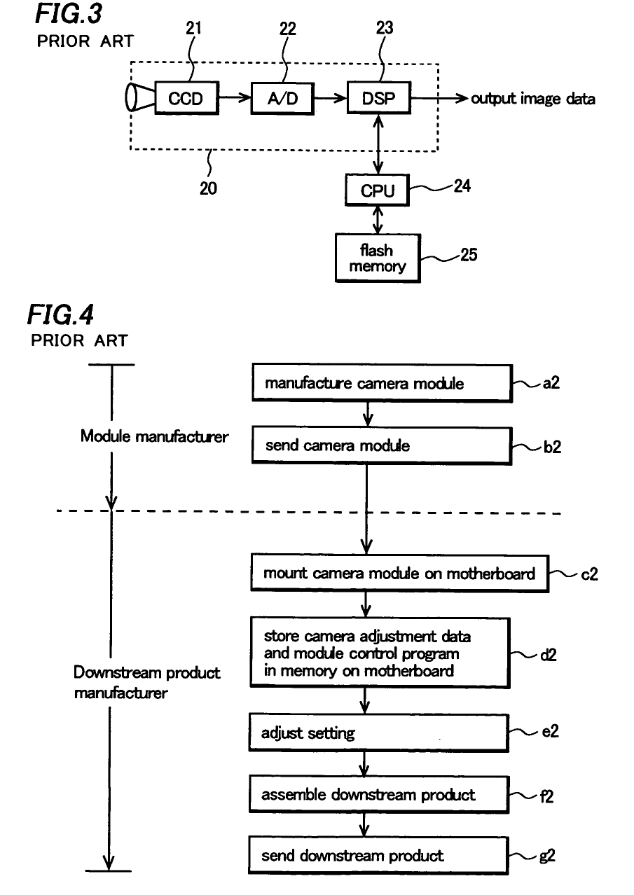

FIG. 1 is a block diagram showing a structure of a camera module of the embodiment of the invention. As shown in FIG. 1, a camera module 10 is configured of a CCD 11 for taking images of objects, an A/D converter 12 for converting an analog image signal outputted from the CCD 11 into a digital image signal, a DSP 13 for processing the digital image signal outputted from the A/D converter 12, and a flash memory 15. The camera module 10 is mounted on a module board (not shown) in a subsequent process step shown in FIG. 2. The flash memory 15 is stored with camera adjustment data and a module control program. The camera adjustment data includes data on adjustment of white balance characteristics of the CCD 11 and adjustment of a mechanical shutter which varies among CCDs or products. The module control program includes sequences for starting the camera module and shifting modes.

The above described camera module 10 is mounted on a motherboard (not shown) by a downstream product (such as a cellular phone) manufacturer. Independently of the camera module 10, a CPU 14 for controlling the DSP 13 is mounted on the motherboard.

Next, an operation of the above described camera module 10 which is assembled into a final product will be described.

The CCD 11 which completes image-taking of an object converts the image into an electrical image signal and outputs it. This image signal is outputted as an analog signal. This analog image signal is converted into a digital signal by the A/D converter 12 and outputted to the DSP 13.

Then, the CPU 14 mounted on the motherboard reads out the module control program, the camera adjustment data (e.g. white balance characteristics) and so on from the flash memory 15 placed in the camera module 10 to the DSP 13, and controls image signal processing (e.g. white balance adjustment) of the DSP 13. By a command of the CPU 14 mounted on the motherboard, the module control program stored in the flash memory 15 is read out and executed.

Next, process steps from adjusting of the above described camera module 10 based on a predetermined camera adjustment data to mounting of the camera module 10 in the downstream product such as a cellular phone will be described with reference to the drawings.

FIG. 2 is a flow chart of steps from manufacturing of the camera module 10 to mounting of the camera module 10 in the downstream product. Among steps a1 to g1 in FIG. 2, the steps a1 to d1 are performed by the module manufacturer as follows.

First, at the step a1, the camera module 10 is manufactured by the module manufacturer to have the above described structure.

Then, at the step b1, the camera adjustment data and the module control program are stored in the flash memory 15 of the manufactured camera module 10. Here, the camera adjustment data include data on adjustment of white balance characteristics of the CCD 11 and adjustment of a mechanical shutter which varies among CCDs or products, for example. Characteristics of each of the CCDs 11, which varies among the CCDs 11, determine an optimal value of the camera adjustment data. The module control program includes sequences for starting the camera module and shifting modes, for example. Each of the sequences of the module control program corresponds to the specification of the camera module 10, which varies among the camera modules 10.

Next, at the step c1, setting of the camera module 10 is automatically adjusted based on the camera adjustment data and the module control program stored in the flash memory 15. That is, the camera module 10 incorporates the camera adjustment data when it is activated

When completing the adjustment of the camera module 10, the camera module 10 is sent to the downstream product manufacturer at the step d1.

Then, the steps e1 to g1 are performed by the downstream product manufacturer as follows.

At the step e1, the adjusted camera module 10, i.e., camera module stored with the camera adjustment data and the module control program, sent from the module manufacturer to the downstream product manufacturer is mounted on the motherboard (not shown).

At the step f1, the motherboard mounted with the camera module 10 is mounted in a downstream product. Then, at the step g1, the downstream product is sent to the market.

The automatic adjustment of the camera module 10, which is performed on the side of the module manufacturer (step c1) in this embodiment, can be performed after the camera module 10 is mounted on the motherboard in the downstream product manufacturing procedure as long as the camera adjustment data and the module control program are stored in the flash memory 15 at the module manufacture side. Alternatively, the automatic adjustment of the camera module 10 can be performed by a buyer of the downstream product after the downstream product is sent to the market (step g1). In this case, a module control program, by which the automatic adjustment of the camera module 10 starts when power is applied to the downstream product, is stored in the flash memory 15.

As described above, the camera adjustment data and the module control program corresponding to the downstream product are stored in the flash memory 15 of the camera module 10 in the camera module manufacturing procedure on the side of the module manufacturer, and then this camera module is sent to the downstream product manufacturer. This can eliminate the step of inputting the camera adjustment data and the module control program in the flash memory 15 in the downstream product manufacturing procedure on the side of the downstream product manufacturer which is a user of the camera module 10. Furthermore, when an error occurs in the camera module 10 or the module control program, action for the error can be performed to the camera module 10 only and is not necessary to the downstream product. This simplifies the downstream product manufacturing procedure, and reduces workload on the part of the downstream product manufacturer.

Incidentally, although the flash memory 15 is used as a memory of the camera module 10 in the above embodiment, the invention is not limited to this and other volatile memory or nonvolatile memory can be used instead.

Furthermore, although the camera adjustment data include data on adjustment of white balance characteristics of the CCD 11 and adjustment of a mechanical shutter which varies among CCDs or products, and so on in this embodiment, the invention is not limited to this and the data can include camera adjustment data or a module control program of other kinds.

1. A method of adjusting a camera module having an imager taking an image of an object, an image processor processing an output signal from the imager, and a memory, the method comprising:
storing in the memory camera adjustment data specific to the camera module;
storing in the memory a module control program for controlling the camera module corresponding to a specification used by an assembler who assembles the camera module into a product; and
sending the camera module containing the camera adjustment data and the module control program therein to the assembler.

2. The method of claim 1, wherein the memory comprises a flash memory.

3. The method of claim 1, wherein the camera adjustment data comprises data on adjustment of white balance characteristics of the imager and data on adjustment of a mechanical shutter of the camera module.

4. The method of claim 1, wherein the module control program comprises a sequence control program for controlling operation of the camera module based on a command of a CPU of the product.

5. The method of claim 1, wherein the camera module comprises an A/D converter converting the output signal from the imager into a digital signal and outputting the digital signal to the image processor.

6. A method of assembling a camera module into a product, the camera module having an imager taking an image of an object, an image processor processing an output signal from the imager, and a memory, the method comprising:
storing in the memory camera adjustment data specific to the camera module;
storing in the memory a module control program for controlling the camera module based on a specification of the product; and
mounting the camera module containing the camera adjustment data and the module control program therein on a board that is part of the product.

7. The method of claim 6, wherein the memory comprises a flash memory.

8. The method of claim 6, wherein the camera adjustment data comprises data on adjustment of white balance characteristics of the imager and data on adjustment of a mechanical shutter of the camera module.

9. The method of claim 6, wherein the module control program comprises a sequence control program for controlling operation of the camera module based on a command of a CPU of the product.

10. The method of claim 6, wherein the camera module comprises an A/D converter converting the output signal from the imager into a digital signal and outputting the digital signal to the image processor.
